(19) United States
(12) Patent Application Publication
(10) Pub. No.: US 2002/0145522 A1
(43) Pub. Date: Oct. 10, 2002

(54) Buddy communicator

(76) Inventor: Kevin Pembroke, Glace Bay (CA)

Correspondence Address: MARKS & CLERK, P.O. BOX 957, STATION B, OTTAWA, ON, K1P 5S7, CA

(21) Appl. No.: 09/826,017

(22) Filed: Apr. 5, 2001

(51) Int. Cl. G08B 23/00

(52) U.S. Cl. 340/573.1; 340/539; 340/407.1; 340/573.4

(57) ABSTRACT

A person-to-person communication system intended to be used in pairs for transmitting and receiving an alarm signal in a noisy environment and to alert a user in other than an audible way. The system comprises a pair of matching interactive devices wearable on the person of respective users co-operating as a team. Each of these communication device comprises a transmitter and a receiver, a control device connected to the receiver, an emergency activation device, and a sensory unit intended to be worn by the user and coupled to its body. The sensory unit is capable of generating a sensory output observable by the user in a noisy environment. The emergency activation device is readily accessible by the user and allows for rapid transmission of an alert signal. A preferred embodiment of the invention is a watch-like device intended to be worn on a wrist of the user and able to generate tactile vibrations to alert the user of an emergency situation.

### FIELD OF THE INVENTION

This invention relates to the field of remote communications and emergency alerting systems operable in a noisy environment and in particular to a communication and alerting device adapted to be worn on a wrist of a user and employing tactile rather then audible means to alert the user of an incoming alarm signal.

### BACKGROUND OF THE INVENTION

In today's world the slightest touch of another human hand on one's hand or shoulder, triggers an immediate alert. Many times this type of communication may be for affectionate reasons, or simply a gesture to get one's attention when some form of danger is present. As the world becomes quickly engulfed in stricter social rules and more sophisticated modern technology, the simplest means of communication such as touching may be considered inappropriate or even old fashioned. Today workers are required to use earplugs in all workplaces where noise levels exceed 85 decibals. Hence, they instantly become hearing impaired, but with the communicator of the present invention they can communicate with each other. Most of our modern day communicators use voice or an audible beep to communicate, but in situations such as hearing impaired persons, wearing ear plugs on the job, or persons in failing health, this would not be appropriate.

It is well known that remote communications and alarm systems are typically designed to indicate an incoming message or a specific emergency situation by furnishing a selected sound within a certain volume range or according to a certain tonality. While these types of communication systems have been generally satisfactory in settings where the noise level is moderate, they are obviously of limited use in noisy environments, such as construction sites, logging, manufacturing and assembly plants, firing ranges, public communication systems, transportation systems, and many others. Furthermore, they are not suitable for hearing impaired persons and for workers obliged to use earplugs.

Portable remote receiving devices have achieved widespread use, particularly in inter-building communication systems or on construction sites where it is necessary to provide for some means of communication between workers. Typically, such devices have two receiving modes: a first pre-signaling or alerting audible tone mode, and a second message-relaying mode. After receiving the alerting tone, the receiving person places the device in the mode for replying to the spoken message.

There are known small sized paging devices capable of providing both audio and tactile vibration signals to alert the person carrying the pager of an incoming signal. U.S. Pat. No. 4,879,759 issued to Matsumoto, et al. on Nov. 7, 1989, shows a pager additionally equipped with a vibrator means. U.S. Pat. No. 4,918,438 issued to Yamasaki on Apr. 17, 1990, describes a paging receiver having an audible and a vibratory annunciating means. U.S. Pat. No. 4,786,889 issued to Hayasaka, shows a battery casing for a paging receiver which includes a vibrating housing as an alerting means. U.S. Pat. No. 4,794,392 issued to Selinko on Dec. 27, 1988, describes another paging device using a vibrator connected to the receiver.

The receiving devices of such communication and alarm systems are of various sizes and use various methods to alert the user in a non-audible way of an incoming signal. There are already known designs delivering tactile sensation to the user based on vibrations produced by a movable mass. Pagers using such means have often the size and appearance of a wristwatch. For example, U.S. Pat. No. 4,225,965 issued to Bush on Sep. 30, 1980, is concerned with a wrist worn device using a movable solenoid core, or probe, capable of prodding the user's wrist through a matching bore in a housing case. The receiving unit described in U.S. Pat. No. 4,380,759 issued to Sulkowski, et al. on Apr. 19, 1983, uses a piezoelectric reed with a tactile member on its end to alert a person when the receiver causes the reed to vibrate.

The prior art is replete with systems intended to be used by hearing impaired or deaf persons for non-audibly signaling monitored events. U.S. Pat. No. 2,580,598 is specifically designed to wake up a deaf person. U.S. Pat. No. 4,421,953 issued to Zielinski on Dec. 20, 1983, is concerned with a tactile telephone alert system converting the telephone alarm signal into a non-audible signal. The device described in U.S. Pat. No. 4,853,674 issued to Kiss on Aug. 1, 1989, uses a set of transmitting modules deployed within the area of a house or an office, each of them monitoring a predetermined set of events: audible events (e.g. baby crying), a telephone line signal, a switch closure, or a transducer output. The transmitter modules are battery operated, lightweight, and movably from one place to another. The pocked size receiver unit has to be carried by the user during his/her daytime activities. Another embodiment of the invention provides for a bed vibrator to allow reception of the alert signal when the user is asleep.

Wristwatches for hearing impaired persons incorporate various advanced and highly miniaturized means to provide for a non-audible alarm signal or even time and date information. EP application No. 349 230, describes a receiving unit which includes a piezoelectric motor driving in rotation an eccentric mass movably mounted on a spindle. U.S. Pat. No. 5,365,497 issued to Born, describes another such alarm device adapted for integration within a timepiece. The design features an electromagnetic motor providing a quasi-linear motion movement of a mass coupled to that motor and furnishing a vibratory effect. The U.S. Pat. No. 5,023,853 issued to Kawata et al, describes a timepiece using an ultrasonic wave motor driving an eccentric weight wheel to produce the vibrations.

Other devices intend to alert hearing impaired persons about a potentially dangerous or hazardous impending happening in their proximity. Some of the designs, as in U.S. Pat. No. 4,237,449 issued to Zibell on Dec. 2, 1980, can automatically detect loud or specific sounds (automobile horn, carbon dioxide, smoke or fire alarm signals, police and emergency signals, barking dogs, door bells, ringing phones, etc.), compare them with a typical background sound level, and control indicator means capable of alerting a user. In this particular design an incoming alarm signal coming from a microphone can trigger on and off a flashing light-emitting diode connected to a person's spectacles, a small vibrator worn on the ear adjacent the mastoid bone of the user or on his/her wrist, or a lamp coupled to the control circuit. The devise described in U.S. Pat. No. 4,297,677 issued to Lewis et al on Oct. 27, 1981, compensates automatically for the ambient noise level and can be activated locally or remotely by a RF signal generated by an auxiliary unit. The signal can be specially encoded to allow individual communication to a specific user in a large group of individuals. The device is intended to be wrist worn but it has a pager's size. U.S. Pat. No. 5,867,105 issued to Hajdel on Feb. 2, 1999, describes a wireless alerting system intended to sense carbon dioxide, smoke or fire hazards and sends the signal to the receiver incorporated into a band being worn on a forearm of the user. This system requires the user to confirm reception of that alarm signal by sending back a confirmation signal to the transmitter. Otherwise, the system will activate its secondary alarm means, different from the primary tactile vibration means.

Another group of patented devices can automatically determine for a given environment situation what kind of sensory simulation to use to alert a user. U.S. Pat. No. 4,918,438 issued to Yamasaki on Apr. 17, 1990, describes a pager that sequentially employs two alerting modes. Initially, it uses the tactile alert, and when the confirmation is not received, it switches to the audible alert. U.S. Pat. No. 5,189,389 issued to DeLuca et al on Feb. 23, 1993, is concerned with a device that automatically changes its alerting mode from tactile to audible upon determination that it is no longer being worn on the person of a user or when it is placed in a charging case. U.S. Pat. No. 5,646,589 issued to Nancy Murray et all on Jul. 8, 1997, switches automatically from audible to tactile actuation only when the ambient sound level is greater then a predetermined threshold level. The device can also detect if it is no longer being worn on the person of a user in which case it switches back its alerting mode to audible.

Networking applications of such non-audible receiving devices are also known. For example, U.S. Pat. No. 5,534,851 issued to Russek on Jul. 9, 1996, is concerned with a medical emergency alarm system that by alerting the personal in a non-audible way prevents the patient from an unnecessary trauma. The system comprises a number of sensory devices remotely sending a coded alarm signal to a central logic control unit and pocket size pagers having vibrational enunciators and a visual display means. The alarm signal can only be terminated manually by an interrupt switch at the bedside.

As it has been shown, the prior art discloses many remote communications and alarm systems that employ non-audible means of alerting a user to an incoming message or an alarm signal. However, there still exists a need for a remote alarm system comprising a simple yet versatile communication device capable of acting as both, a transmitter and a receiver, and intended to work in pairs, thus allowing “buddy”-like co-operation between users. Such device should be reliable, small, light, and easy to carry around (much like a wristwatch), yet featuring a readily accessible activation device allowing for instant transmission of an alarm signal. Existing networking devices are still too bulky and they do not permit easy differentiation of one of the users in a group of other persons.

Such an alarm system would be used on construction sites, factories, logging sites, and in other high-noise environments where workers co-operate in teams and they could be faced with a potentially hazardous situation. The system can be used to send an instant warning signal to a “buddy” worker or to send a “help me” signal in a situation where one of the workers has had an accident and is in need of immediate assistance. Ultimately, it can be employed by permanently hearing impaired persons forming “buddy” teams either at work or in their everyday activities.

### SUMMARY OF THE INVENTION

The “buddy” communicator system of the present invention is a person-to-person emergency alerting system using non-audible means to alert a person of an incoming alarm signal. The system comprises a pair of matching interactive devices wearable on the person of respective users working or co-operating as a team. Each one of these communication devices comprises a transmitter and a receiver, an emergency activation device, a sensory unit and a control device. All of the components are typically arranged in a single housing intended to be worn on a person of a user and coupled to its body.

This invention can be used in high-noise environments where workers could not hear an audible alarm signal or they would be required to wear earplugs for safety reasons. It can be also used as a communication and alarm aid for temporary or permanently hearing impaired persons. Furthermore, the invention can be employed as a bi-directional multi-functional communication device for every day applications. It could allow a user to set up a series of codes to alert a second user or “buddy” when certain events are about to take place.

A preferred embodiment of the invention is a watch-like device attached by a strip band or other attachable means to a wrist of the user and able to generate tactile vibrations to alert the user of an emergency situation or the like. A coded signal can be used to transmit the alert signal, which may be in a form of a RF signal.

These and other objects and features of the present invention will become more fully apparent when read in connection with the following detailed description of the invention, and the accompanying drawings showing the block diagram of the invention and two views of the preferred embodiment.

### BRIEF DESCRIPTION OF THE DRAWINGS

FIG. 1 is a block diagram of the “buddy” communicator device.

FIG. 2 is a top view of the preferred embodiment of the “buddy” communicator device.

FIG. 3 is a side view of the preferred embodiment of the “buddy” communicator device.

### DETAILED DESCRIPTION OF THE INVENTION

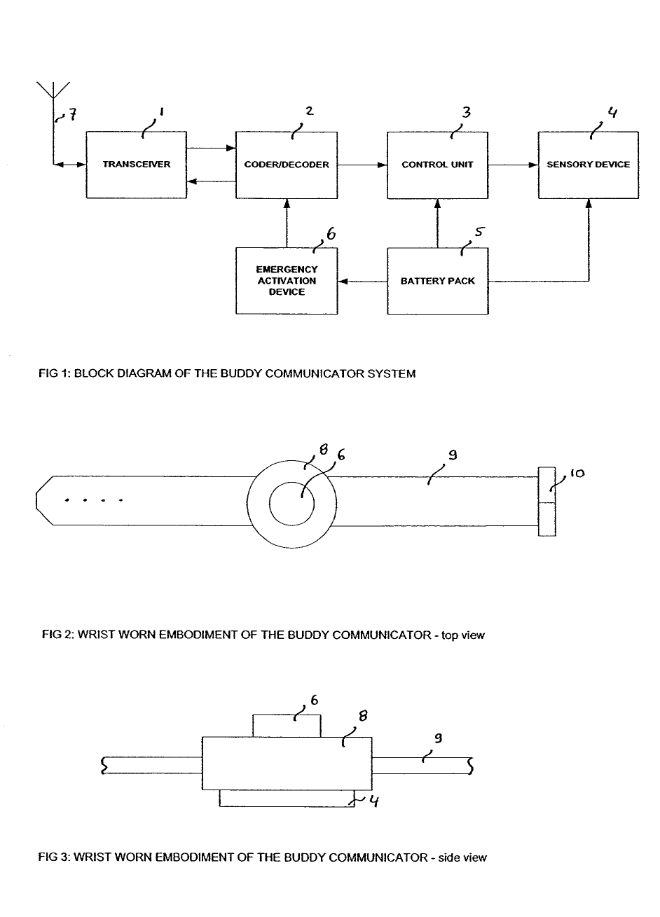

The “buddy” communicator system comprises a pair of matching interactive devices wearable on the person of respective users co-operating as a team. All of the following drawings refer to a single device while the actual system will be sold and operated in pairs. FIG. 1 represents a block diagram of a first embodiment of the “buddy” communicator device, which comprises a limited number of interconnected components: a transceiver 1, an emergency activation device 6, a control unit 3 and a sensory device 4. The coder/decoder unit 2 featured in FIG. 1 is not essential for proper functioning of the system according to its first embodiment but it is included in subsequent embodiments, where the transmitted signal is coded. All the above mentioned units are powered from the battery unit 5. The technical design of any one of the units included in the system has been already disclosed in the prior art and is easily available to a person skilled in the art.

Both matching devices of the system have transmitting and receiving capabilities. The transmission mode will be described first. Upon activation of the emergency activation device 6, which is readily accessible by the user, an electrical signal from the battery pack 5 is passed to the transceiver 1. The transceiver unit transmits through antenna 7 a remote alert signal to the other matching device of the pair. Before transmission, the signal could be coded in the coder/decoder unit 2 connected to the emergency activation device 6 and to the transceiver 1. The use of a RF signal in the preferred embodiment of the invention allows the transmission range to be up to 1000 feet. Additionally, the receiving device of the “buddy” communicator system can be out of “sight” of the transmitting module.

The remote signal sent to a “buddy” worker should warn him about possibly hazardous situation or about an imminent danger. Another situation would happen, when one of the workers has had an accident and he is in a need of immediate assistance. Using the “buddy” communicator device he would be able to send a “help me” signal. Since the system is purposely intended to use the device in pairs only, there is always a certainty about from where the alarm signal is coming and where to address immediate assistance.

The following description is concerned now with the “buddy” communicator device working as a receiver. The remote alert signal from the antenna 7 is passed to the transceiver 1 and further routed to the control unit 3. In a case when the received signal is coded it will have to be decoded in the coder/decoder unit 2 first. The control unit 3 activates and controls the sensory device 5 coupled to the body of the user and capable of transforming the incoming electrical signal into a sensory, non-audible signal. Such non-audible signals, easily observable by the user in a noisy environment, can include, but are not limited to: tactile vibrations, pulsating micro light bulb or flashing light-emitting diode, a low voltage electrical stimulation signals, or other signals. Depending on the nature of the sensation used and on the means to deliver the sensation to the person of the user, the control unit contains appropriate driver circuits (e.g. an electronic switch combined with a multivibrator), which design is well known to a person skilled in the art. A timing device may be used to control the duration of the alert signal and to prevent the battery from being discharged.

FIG. 2 represents a top view of the preferred embodiment of the “buddy” communicator device resembling a typical wristwatch. The central housing unit 8 contains all the electronic modules described above, the emergency activation device 6, and the sensory device 4 as seen in FIG. 3. The housing is mounted on a wrist of the user by a strip band 9 with a typical buckle 10 or any other attaching means. The emergency activation device 6, which may be a standard push button, is centrally located in the housing unit 8 and large enough to allow for instant access and rapid execution of an alarm signal. It would be preferable to vary the colors of the emergency activation device and the housing unit to further enhance the accessibility aspect of the invention.

FIG. 3 is a side view of the preferred embodiment of the “buddy” communicator device. The sensory device 4 is located underneath of the housing unit 8 to allow for coupling it to the wrist of the user. Various means could be used to transmit the tactile vibrations and indicate an emergency situation. Some of those means can include a movable probe capable of partially extending outside the housing unit of the device to generate the tactile vibrations. Such a probe could be a core of a solenoid attached in proximity of a bore in the housing or it could be driven by an electric, piezoelectric, or any other motor. Another embodiment of the invention can employ piezoelectric means to produce the alerting vibration signal. Furthermore, embodiments of the invention using tactile vibrations as an alerting signal could have various design: a device adapted to be worn on a wrist of a user in a manner similar to a wristwatch, a miniaturized unit worn on the ear adjacent the mastoid bone, or a pocket sized pager. Yet another embodiment of the invention is concerned with a communications and emergency alerting system employing a finite number of matching interactive communication devices configured to work in a network, each said device wearable on the person of respective users co-operating as a team.

Possible applications of the “buddy” communicator device system are endless and could include: hospitals and other medical situations, disability situations, manufacturing and assembly plants, steel plants, fish plants, mines, construction sites, firing ranges, parent-child supervision, senior and hearing impaired persons supervision, security operations, fire workers communications, and many other applications. In particular, following scenarios could be observed:

1. A worker is on a construction site and he/she is wearing earplugs. A co-worker is trying to get his/her attention by yelling and waving his/her arms. With the “buddy” communicator he/she would only need to push the activation button to get the immediate attention of his “buddy.”

2. The “buddy” communicator will upgrade the lifestyle of someone who is temporarily or permanently hearing impaired by giving that person a means of communication.

3. The “buddy” communicator can be used as a signaling device for many day-to-day applications such as: (a) Doing repair work around the outside of your home while a family member is ill inside. (b) Keeping track of your kids while they are playing outside. (c) An opportunity for seniors to feel more secure. (d) It could be used as a doorbell for hearing-impaired persons, or as a warning device in case of a danger.

Although a preferred embodiment of the invention has been disclosed herein, it is recognized that modifications and variations will occur to those skilled in the art and consequently it is intended that the appended claims be interpreted to cover such modifications and other equivalents. In particular, the means employed to deliver the non-audible sensations to alert the user of an incoming alert signal as well as the location of the sensory unit on the body of the user could vary significantly. By setting a series of codes easily recognizable to the users, the “buddy” communicator device can become a bi-directional communication instrument capable of acting as a multifunctional device.

claims:

1. A person-to-person emergency alerting system, comprising a pair of matching interactive communication devices wearable on the person of respective users co-operating as a team, each said interactive communication device comprising:
a transmitter and receiver for sending a remote signal to, and receiving a remote signal from, the respective receiver and transmitter of the other device of said pair;
an emergency activation device readily accessible by the user and operable in response to rapid activation by said user to send a said remote signal from said transmitter to said other device of said pair;
a sensory device that when a said communication device is worn by a said user can be directly coupled to the body of the user so as to generate a sensory output observable by said user in a noisy environment; and
a control unit connected to said receiver for activating said sensory device in response to the receipt of said remote signal from said other device of said pair.

2. A person-to-person emergency alerting system as in claim 1, further including coding means, wherein said remote signal is a coded signal.

3. A person-to-person emergency alerting system as in claim 1 wherein said remote signal is a RF signal.

4. A person-to-person emergency alerting system as in claim 1 wherein each one of said communication devices is attached to a strip band and worn on a wrist of said user.

5. A person-to-person emergency alerting system as in claim 1 wherein said sensory output generated by said sensory device consists of tactile vibrations.

6. A person-to-person emergency alerting system as in claim 5 wherein said sensory device includes a movable probe controlled by said control unit and capable of partially extending outside a core of said communication device to generate said tactile vibrations.

7. A person-to-person emergency alerting system as in claim 5 wherein said sensory device uses piezoelectric means to generate said tactile vibrations.

8. A person-to-person emergency alerting system as in claim 1 wherein said control unit includes a timing means capable of automatically switching said sensory device off.

9. A person-to-person emergency alerting system as in claim 1, employed as a part of a door bell system for hearing impaired person, wherein existing door bell means are adapted to activate one of said communication devices upon activation of said door means by a visitor, said communication device sending a remote signal to be received by said other matching device of the pair and worn by said hearing impaired person.

10. A communications and emergency alerting system employing a finite number of matching interactive communication devices configured to work in a network, each said device wearable on the person of respective users co-operating as a team and comprising:
a transmitter and receiver for sending a remote signal to, and receiving a remote signal from, the respective receiver and transmitter of any other device of said system;
an emergency activation device readily accessible by the user and operable in response to rapid activation by said user to send a said remote signal from said transmitter to said other device of said system;
a sensory device that when a said communication device is worn by a said user can be directly coupled to the body of the user so as to generate a sensory output observable by said user in a noisy environment; and
a control unit connected to said receiver for activating said sensory device in response to the receipt of said remote signal from said other device of said system.
